(19) United States
(12) Patent Application Publication
(10) Pub. No.: US 2016/0003573 A1
(43) Pub. Date: Jan. 7, 2016

(54) Vehicle Mounted Slingshot Frame

(71) Applicant: Charles Leif Johnston, Fredericksburg, VA (US)

(72) Inventor: Charles Leif Johnston, Fredericksburg, VA (US)

(21) Appl. No.: 14/789,179

(22) Filed: Jul. 1, 2015

Related U.S. Application Data
(60) Provisional application No. 62/019,891, filed on Jul. 2, 2014.

(51) Int. Cl. F41B 3/02; B60D 1/24

(52) U.S. Cl. CPC F41B 3/02; B60D 1/24

(57) ABSTRACT

A slingshot frame mounted to the trailer hitch receiver on a pick-up truck provides a slingshot that can be easily moved from place to place. The frame can be of a variety of configurations that allows a vertical component to be integrated to a horizontal section used in a standard 1.25 or 2 inch trailer hitch mount.

### CROSS-REFERENCE TO RELATED APPLICATIONS

This application is a follow up to provisional utility application Ser. No. 62/019,891 dated Jul. 2, 2014 by Charles Leif Johnston and therefore, claims all benefits pertaining thereto.

### BRIEF SUMMARY OF THE INVENTION

This patent focused on the creation of a truck mounted slingshot for recreational or agricultural uses. Using the receiver hitch as a mount point and a frame, a large format slingshot can be mounted to a truck an easily moved. This large easily moveable slingshot can then be used for recreational purposes, throwing water balloons, shooting targets or other objects to make real life versions of video games. Similarly, for agricultural purposes bundles could be launched to create feed plots, distribute pesticides or the like. With the ability to launch a soda can weighing 6-12 ounces more than 275 feet, there are many ways to use this invention.

### STATEMENT REGARDING FEDERALLY SPONSORED RESEARCH OR DEVELOPMENT

Not Applicable.

### BACKGROUND OF THE INVENTION

As a part of the initial development of a recreational tool, we developed the idea of a hitch mounted slingshot. Exploiting the idea and designs of the “3 person slingshot” for water balloons marketed under brand names including: “Stream Machine”, “Kaos Catapult” and others, we sought a frame mounted invention to allow the slingshot to be operated by 1 person.

Moreover, we wanted a way to make the mount moveable and so the idea of using a truck receiver hitch was exploited. Our receiver mount design could be mounted on 1.25 inch, 2 inch or similar receiver tubes where the slingshot can use the vehicle frame for increased stability. Our initial slingshot was made by mounting a Stream Machine slingshot on our frame and positioned either in a pickup truck receiver hitch mount or as an in ground mounted system. The frames for this system were made of metal tubing and the connectors to the receiver hitch were tried with both a square tubing variant and a solid metal connection method. In general, the square tubing solution would likely be simpler and less expensive to manufacture. And while we used a 2 inch receiver hitch as our particular embodiment, and size receiver hitch could be used allowing the frame to be run from ATVs to large farming trucks.

A trailer hitch receiver tube, also known as a tow hitch, is a device that is physically attached to the rear frame of a vehicle, in which a ball mount is traditionally inserted to enable towing capabilities. Many trailer hitches have an opening, or receiver, in which accessories or other attachment options may be inserted. Trailer hitch attachments come in different shapes and sizes, and could be designed for any size trailer hitch, which typically range in sizes from 1.25-2.5 inches. North American trailer hitches are classified by the Society of Automobile Engineers (SAE) specification J684 and common classifications include Class I, II, III, and IV. Our designs could be developed for any class of receiver hitch.

Traditionally trailer hitches are secured to a vehicle's chassis and are structurally designed to tow large, and at times heavy, loads depending on the make of the vehicle. There are many attachments that exploit the receiver hitch to provide the stability of the vehicle as a counter weight to use the object. Examples include chairs, tables, and charcoal grills. While slingshots are considered in spring actuated projectile launchers (USPC 124/16) they are specifically subcategorized into USPC 124/17. In the specific case of this invention since the focus is less on the mechanism of the slingshot and more on the frame, the logical classification of the invention might best be USPC 124/29, mounted projectile launchers. International classification is likely to remain vehicle mounting sports gear B60R9/08.

The following prior art reflects the state of the art of which applicant is aware and is included to discharge applicant's duty to disclose relevant prior art. It is stipulated, however, that none of these references teach singly nor render obvious when considered in any permissible combination the invention as disclosed in greater detail hereinafter and as particularly claimed.

| PATENT NO. | ISSUE DATE | INVENTOR |
|---|---|---|
| U.S. Pat. No. 6,173,705 | Jan. 16, 2001 | DeWitt |
| U.S. Pat. No. 5,451,088 | Sep. 19, 1995 | Broad |
| U.S. Pat. No. 5,803,330 | Sep. 8, 1998 | Stack, et al. |
| U.S. Pat. No. 6,684,550 | Feb. 3, 2004 | Highfill |
| U.S. Pat. No. 8,166,695 | Mar. 22, 2010 | Pippin |
| U.S. Pat. No. 5,221,241 | Jun. 22, 1993 | Bare |
| U.S. Pat. No. 5,421,783 | Jun. 6, 1995 | Kockelman, et al. |

U.S. Pat. No. 6,173,705 teaches mounting a spring loaded projectile launcher onto a receiver hitch mount. The focus of that mount is to stabilize the heavy throwing arm of a skeet thrower rather than the lighter structure of a slingshot. The skeet frame is low and the device is operated from the ground next to the open tailgate of the truck vs. standing in the truck operating a slingshot. The correlation to the spring mounted launcher and using the truck as a storage platform are instructional.

U.S. Pat. No. 5,451,088 teaches a structural support system that is intended to extend the carrying length of a truck bed. Structurally, the supporting frame for the slingshot is most easily implemented using steel tubing and therefore, this approach is similar to the referenced patent.

U.S. Pat. No. 5,221,241 and U.S. Pat. No. 5,421,783 teaches about very large format spring and elastic/slingshot frames for vertically launching heavy objects in a kind of bungee bounce amusement ride. Both provide some interesting context for heavy frames, but neither example reflects effectively on the claimed invention since their focus is primarily not to launch the projectile and so the frames have a vertical primary component for the slingshot angle.

### SUMMARY OF THE INVENTION

The invention is hitch mounted large format slingshot primarily, but not specifically, for recreational or agricultural use. A large, two to six foot wide, slingshot frame supports a slingshot connected to the receiver hitch of a vehicle through one or more mounting components. In the embodiment of a pickup truck the user then uses the pickup truck bed as a standing platform to stretch the slingshot and launch soda can sized projectiles. The specific projectiles that can be launched are not limited by the embodiment discussed, even though aluminum cans were the focus of our embodiment. The invention as created can launch an aluminum can more than 250 feet in the air at speeds in excess of eighty miles per hour. We have launched, balls, stuffed animals, seed balls and many other things and the specifics are not intended to limit the invention. The invention simplifies the use of the three person water balloon style slingshots allowing them to be used by one person and easily moved.

### BRIEF DESCRIPTION OF THE FIGURES

FIG. 1 shows the system from the side of the receiver hitch.

FIG. 2 shows the system opposite from and facing the receiver hitch which is hidden from view.

### DETAILED DESCRIPTION OF THE INVENTION

The following figures are practical illustrations of exemplary embodiments of the present invention, which do not limit the scope or objectives of the invention. The figures should be used in conjunction with the explanations in the following detailed description.

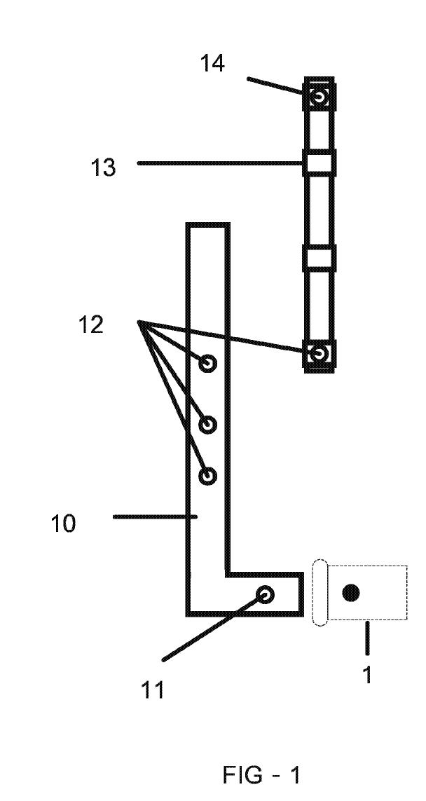

FIG. 1 illustrates the mounting mechanisms from the side view of the receiver hitch and focuses on the integration with the receiver hitch. Item 1 is the receiver hitch in outline. Item 10 shows the lower mount tube with an approximate right angle bend to transition from the horizontal plane of the receiver hitch to the vertical needed to support the slingshot. Item 11 is the receiver hitch pin hole so that the bottom section of the lower mount tube can slide into the receiver hitch and be pinned into place through hole 11. Items 12 are the adjustment pin holes for the upper tube assembly support. A cotter pin is put through one of those holes to set the height of the slingshot. If the pin goes through the hole on the upper tube assembly then the slingshot will not rotate or come free from the receiver tube. If the pin is set below the upper receiver tube, then the slingshot is free to rotate or be easily removed for storage. Item 13 is the upper tube assembly with the adjustment pin hole at the bottom and the frame face connection at the top of the tube. In this embodiment, bushings are shown on the upper tube assembly to better mate with the lower mount tube. The frame face is not shown in FIG. 1.

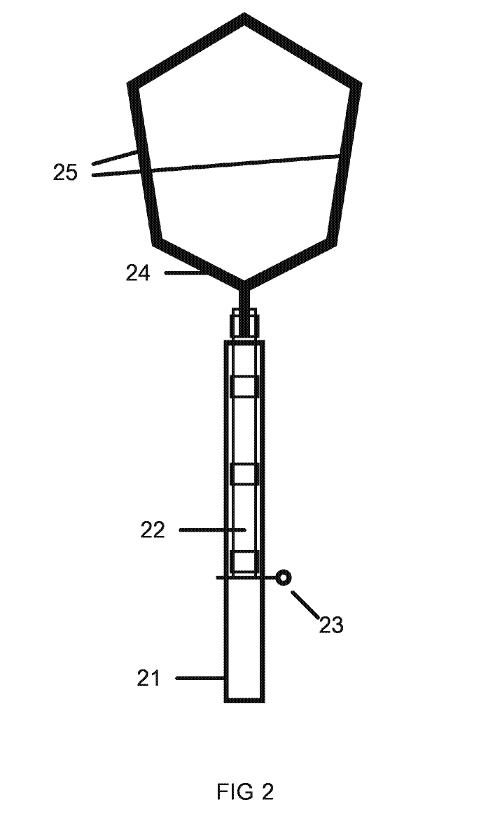

FIG. 2 provides a face on perspective in line with the receiver hitch which is hidden from view behind the diagram. This view shows one embodiment of the components assembled. Item 21 is the lower mount tube. The upper tube assembly, Item 22, is inserted into the lower mount tube and the height of the upper receiver is controlled by the cotter pin Item 23. Item 24 is one embodiment of the frame face that supports the sling shot attachment at the 2 points denoted as Item 25. The face frame is bolted to the upper receiver tube, but that connection is not shown.

The resulting system provides a frame with ample width to support the large surgical tubing slingshots available on the market. Flat band slingshots could also be mounted on the frame. The tube assemblies are the most likely embodiment based on cost to manufacture, but we have made a solid lower mount assembly and that is intended to be covered by this patent design. The design permits rotation of the slingshot frame for aiming, or pinning the slingshot in place for travel or safety. The result of this invention is the ability to mount a large slingshot on a vehicle with the most logical embodiment being an open bed pickup truck, though all mounting methods with a receiver hitch are claimed.

What is claimed:

1. A hitch receiver mounted frame for a slingshot allowing it to be easily connected to a truck, ATV, trailer, car or other vehicle frame using the trailer hitch of said vehicle.

2. The pivoting slingshot frame and mechanism for the same system.

3. The equivalent ground mountable slingshot frame.

4. The system of combining these parts to make an easily movable large form factor slingshot.
